(19) United States
(12) Patent Application Publication
(10) Pub. No.: US 2015/0067237 A1
(43) Pub. Date: Mar. 5, 2015

(54) MEMORY CONTROLLER, SEMICONDUCTOR MEMORY SYSTEM, AND MEMORY CONTROL METHOD

(71) Applicant: Kabushiki Kaisha Toshiba, Minato-ku (JP)

(72) Inventors: Kenichiro YOSHII, Bunkyo-ku (JP); Konosuke WATANABE, Nakagun Ninomiya-machi (JP); Naoto OSHIYAMA, Ota-ku (JP); Satoshi KABURAKI, Shinagawa-ku (JP)

(73) Assignee: Kabushiki Kaisha Toshiba, Minato-ku (JP)

(21) Appl. No.: 14/193,706

(22) Filed: Feb. 28, 2014

Related U.S. Application Data
(60) Provisional application No. 61/873,871, filed on Sep. 5, 2013.

(51) Int. Cl. G06F 12/02; G06F 12/10

(52) U.S. Cl. CPC G06F 12/0246; G06F 12/1054; G06F 2212/7201
USPC 711/103

(57) ABSTRACT

According to one embodiment, a memory controller includes an address translation information storage unit that stores plural translation information formed by classifying a correspondence between a logical address and a physical address into two or more hierarchies, a tag management unit that sores a cache line tag, which includes hierarchy information corresponding to each of the translation information stored in the translation information storage unit, and a control unit that identities whether the translation information is stored in the translation information storage unit or not by using a cache line tag.

### CROSS-REFERENCE TO RELATED APPLICATIONS

This application is based upon and claims the benefit of priority from Provisional Patent Application No. 61/873871, filed on Sep. 5, 2013; the entire contents of which are incorporated herein by reference.

### FIELD

Embodiments described herein relate generally to a memory controller, a semiconductor memory system, and a memory control method.

### BACKGROUND

A memory system such as a hard disk drive or a solid state drive manages a correspondence between a logical address and a physical address of user data recorded in the memory system as address translation information. The logical address is used for the identification of the user data by a host. The physical address is used for the identification of a recorded position of the user data in the memory system. The memory system executes reading and writing the user data by referring to the address translation information.

### BRIEF DESCRIPTION OF THE DRAWINGS

FIG. 1 is a diagram illustrating an example of a configuration of a memory system according to a first embodiment;

FIG. 2 is a view illustrating an example of a configuration of address translation information according to the first embodiment;

FIG. 3 is a view illustrating one example of a correspondence between a cache line and a cache line tag according to the first embodiment;

FIG. 4 is a view illustrating an example of a configuration of the cache line tag according to the first embodiment;

FIG. 5 is a flowchart illustrating one example of an operation procedure upon a reception of a read command;

FIG. 6 is a flowchart illustrating one example of a procedure of reading an address translation table from NAND flash memory according to the first embodiment;

FIG. 7 is a view illustrating one example of an address translation process;

FIG. 8 is a view illustrating an example of a configuration of an address translation information tag management unit;

FIG. 9 is a view illustrating one example of a procedure of a table search and the address translation process;

FIG. 10 is a flowchart illustrating one example of an overall process of a search in the address translation information tag management unit;

FIG. 11 is a flowchart illustrating one example of a process executed by a tag memory operation unit;

FIG. 12 is a view illustrating an example of a configuration of an address translation information tag management unit according to a second embodiment; and

FIG. 13 is a view illustrating an example of a configuration of a cache line tag according to a third embodiment.

### DETAILED DESCRIPTION

In general, according to one embodiment, a memory controller includes an address translation information storage unit that stores some of plural translation information formed by classifying a correspondence between a logical address and a physical address into two or more hierarchies, and a tag management unit that stores a cache line tag, which includes hierarchy information corresponding to each of the translation information stored in the translation information storage unit. The memory controller identifies whether the translation information is stored in the translation information storage unit or not by using a cache line tag.

Exemplary embodiments of a memory controller, a semiconductor memory system, and a memory control method will be explained below in detail with reference to the accompanying drawings. The present invention is not limited to the following embodiments.

### First Embodiment

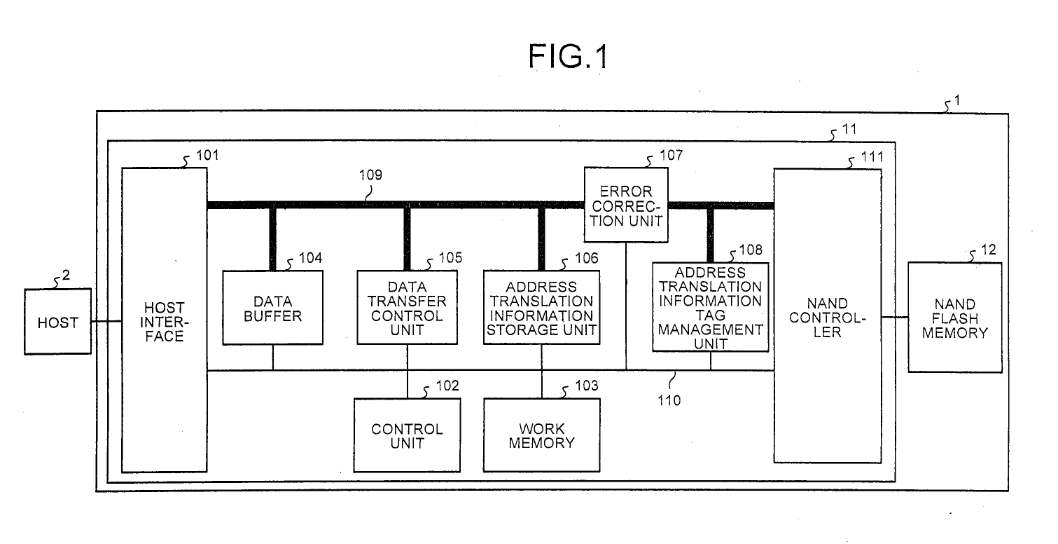

FIG. 1 is a diagram illustrating an example of a configuration of a memory system 1 according to a first embodiment. The memory system 1 includes NAND flash memory 12 (non-volatile memory) and a memory controller 11. The semiconductor storage device 1 is connectable to a host 2. In FIG. 1, a state in which the semiconductor storage device 1 is connected to the host 2 is shown. The host 2 is, for example, an electronic apparatus such as a personal computer or a portable terminal.

The NAND flash memory 12 is non-volatile memory that stores data in a non-volatile manner. In this embodiment, the NAND flash memory (hereinafter referred to as NAND memory according to need) is used as the non-volatile memory in the memory system. However, a memory other than the NAND memory may be used. In the NAND memory, in general, data is written and read out for each of write unit data called page.

The memory controller 11 includes a host interface 101 (first interface), a control unit 102, a work memory 103, a data buffer 104, a data transfer control unit 105, an address translation information storage unit 106, an error correction unit 107, an address translation information tag management unit 108 (tag management unit), a data bus 109, a control bus 110, and a NAND controller 111 (second interface).

The host interface 101 outputs a command or user data received from the host 2 to the control bus 110 and the data bus 109. The host interface 101 also transmits user data read from the NAND flash memory 12 or a response from the control unit 102 to the host 2.

The control unit 102 entirely controls the memory system 1. The control unit 102 is a CPU (Central Processing Unit), or an MPU (Micro Processing Unit), for example. When receiving a command from the host 2 via the host interface 101, the control unit 102 executes control according to this command. For example, the control unit 102 instructs the NAND controller 111 to write the user data or parity to the NAND flash memory 12 or to read the user data or parity from the NAND flash memory 12 according to the command from the host 2. The work memory 103 is used by the control unit 102 for various processes.

The data buffer 104 temporarily stores the data received from the host 2 until this data is stored in the NAND flash memory 12, or temporarily stores the data read from the NAND flash memory 12 until this data is transmitted to the host 2. For example, the data buffer 104 is composed of general-purpose memory such as SRAM (Static Random Access Memory) or DRAM (Dynamic Random Access Memory).

The data transfer control unit 105 controls the data transfer via the data bus 109, such as the data transfer between the data buffer 104 and the NAND flash memory 12 or the data transfer between the data buffer 104 and the host 2 via the host interface 101, based upon the instruction from the control unit 102.

The NAND controller 111 controls, based on an instruction of the control unit 102, processing for writing user data and the like in the NAND flash memory 12 and processing for readout from the NAND flash memory 12.

The error correction unit 107 executes an error correction coding by using the data to be written onto the NAND flash memory 12, thereby generating parity. The error correction unit 107 also executes the error correction process by using the data and parity read from the NAND flash memory 12.

The address translation information storage unit 106 is a memory for storing address translation information. It is composed of SRAM or DRAM, for example. The address translation information tag management unit 108 manages whether the address translation information is stored in the address translation information storage unit 106 or not.

The memory controller 11 holds the correspondence between a logical address used for identifying the user data by the host 2 and a physical address used for identifying the recording position in the NAND flash memory 12 as the address translation information. When receiving a write command from the host 2, the control unit 102 in the memory controller 11 obtains, by a predetermined method, the physical address that indicates the position, in the NAND flash memory 12, in which the user data designated by the write command is written. The control unit 102 also instructs the data transfer control unit 105 to transfer the user data to the NAND controller 111. The NAND controller 111 controls to write the user data on the designated storage position in the NAND flash memory 12 based upon the instruction from the control unit 102. After writing of the user data, the control unit 102 holds a logical address, of the user data, received from the host 2 and the physical address, in which the user data is stored, as a newly address translation information.

When receiving a read command from the host 2, the control unit 102 resolves the physical address from the logical address of the user data designated by the read command using the address translation information. The control unit 102 then instructs the NAND controller 111 to read the read data from the position, indicated by the resolved physical address, in the NAND flash memory 12. The NAND controller 111 reads the user data from the designated storage position in the NAND flash memory 12. The data transfer control unit 105 transfers the user data, which is read from the NAND flash memory 12, to the host 2 via the host interface 101.

The address translation information is specifically information including a set of a logical address and a physical address. It is supposed that a set formed simply by one-to-one correspondence of the logical address and the physical address is held as the address translation information. In this case, when the memory capacity of the memory system 1 is large, the data size of the address translation information also increases. For example, when the memory system 1 with the capacity of 64 gigabytes manages the user data in a unit of four kilobytes, 16777216 sets of address translation information are needed. When the size of the address translation information of one logical address is eight bytes, the size of the address translation information becomes 128 megabytes. When the data of this size is held in the NAND controller 111, the capacity of the memory such as SRAM provided in the memory controller 11 increases, whereby cost increases.

On the other hand, it is considered that the address translation information is written into the NAND flash memory 12. However, in this case, it takes time to read the address translation information, resulting in that the writing time and the reading time of the user data increase. In order to solve the problems described above, there has been proposed a method of managing the address translation information as a hierarchical table (translation information). The plural tables are written into the NAND flash memory 12, and some of the information is held in the memory controller 11.

For example, it is supposed that the address translation information is hierarchically managed by using three hierarchical tables. The table (the third table) on the third hierarchy (the lowermost hierarchy) is the information including a set of a logical address and a physical address. One third table is generated for one entry of a later-described table (the second table) on the second hierarchy. The second table is the information indicating an address range and the information indicating the storage position (the physical address in the NAND flash memory 12) in the third table corresponding to the address range. One second table is generated for one entry of a later-described table (first table) on the first hierarchy. The first table is information indicating an address range and information indicating the storage position in the second table corresponding to the address range.

For example, when the capacity of the memory system 1 is 64 gigabytes, one entry of the first table is generated for each of the address range of 16 megabytes. The number of the entries of the first table is 4096 (64 gigabytes/16 megabytes). When the data size of one entry is eight bytes, the data size of the address translation information on the first hierarchy becomes 32 kilobytes. Therefore, the data size of the first table is small, so that it is no problem if the memory controller 11 holds the first table. The second and third tables are stored in the NAND flash memory 12. Accordingly, the memory controller 11 firstly acquires the storage position in the second table by referring to the first table in the logical address, and reads the second table, during the data reading. Then, the memory controller 11 acquires the storage position in the third table by referring to the second table, and reads the third table. Finally, the memory controller 11 can acquire the physical address corresponding to the logical address by referring to the third table.

The embodiment described above shows that the memory controller 11 holds only the first table. However, the memory controller 11 generally holds not only the first table but also one or more of the second table and the third table. For example, the table that has been used once has high possibility of being again used within a certain period of time. Therefore, it is desirable to hold such table on the memory in the memory controller 11. When tables of plural hierarchies are held on the memory in the memory controller 11, it is considered that the memory area in the memory controller 11 is divided for each hierarchy to determine the area for storing the table of each hierarchy, in order to easily manage whether the table of each hierarchy is held on the memory in the memory controller 11 or not. However, in this method, when there is no space in the storage area for the third table, the third table cannot be added and held even if there is a space in the area for storing the second table. As described above, the method of determining the area for storing the table of each hierarchy cannot effectively utilize the memory in the memory controller 11.

On the other hand, when the area for storing a table of each hierarchy is not determined, but the first to third tables are all stored in one memory area in the memory controller 11, a process of searching which table of which hierarchy is present in the memory controller 11 becomes very complicated, resulting in that it takes much time to search. In the present embodiment, the information for managing the hierarchy of the address translation information is employed to execute the search in order to enhance the use efficiency of the memory in the memory controller 11 and to shorten the search time as to whether the table is held in the memory controller 11.

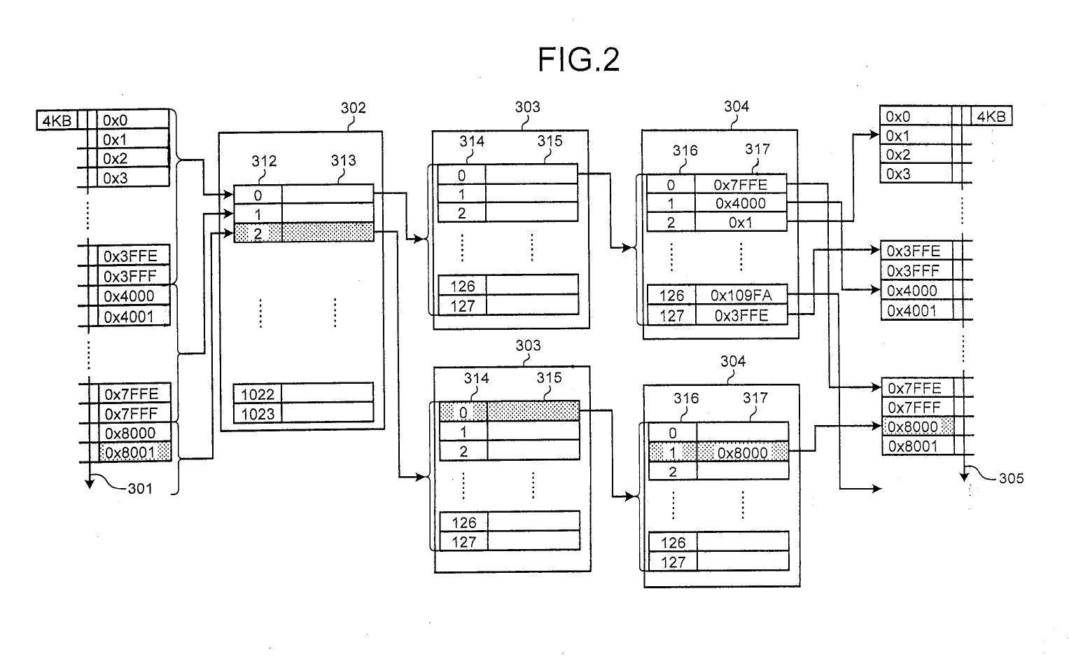

The method of managing the address translation information according to the present embodiment will be described. FIG. 2 is a view illustrating an example of a configuration of the address translation information according to the present embodiment. In FIG. 2, a logical address space 301 indicates a space of a logical address of a user address every four kilobytes, while a physical address space 305 indicates a space of a physical address of the user address every four kilobytes. The logical address space 301 is a space defined by a protocol of an interface connecting the host 2 and the memory system 1. For example, when the memory system 1 is connected with the host 2 with the protocol of Serial ATA (SATA) or Small Computer System Interface (SCSI), the logical address is assigned in a unit of 512 bytes or four kilobytes. The value obtained by multiplying the maximum value of the logical address by the unit size of the logical address (e.g., four kilobytes) becomes a displayed capacity declared by the memory system 1 to the host 2.

In the present embodiment, tables of three hierarchies are used as illustrated in FIG. 2 in order to acquire the physical address in the physical address space 305 corresponding to the logical address in the logical address space 301. FIG. 2 illustrates an example in which the logical address is assigned in 4-kilobyte units. 16384 consecutive logical addresses are bundled in one bundle in the logical address space 301 illustrated in the left end in FIG. 2. A first index is applied to each of the bundles, each including 16384 logical addresses. The first table 302 is composed of a first index 312 and a storage position 313 of the second table (the physical address in the NAND flash memory 12) including the information involved with the bundle of the logical address indicated by the first index 312. One second table 303 is generated for each of the bundle having 16384 logical addresses, i.e., for each first index. In FIG. 2, 1024 first indexes from 0 to 1023 are present. Therefore, 1024 second tables 303 are generated.

128 logical addresses of 16384 logical addresses corresponding to the first index are bundled as one bundle. A second index is applied to each of the bundles, each including 128 logical addresses. The second table 303 is composed of a second index 314 and a storage position 315 of the third table (the physical address in the NAND flash memory 12) including the information involved with the bundle of the logical address indicated by the second index 314. The third table 304 is generated for each bundle including 128 logical addresses. Specifically, the third tables 304 in (the number of the second table)×(the number of the second index) (=1024×128) are generated.

The third table 304 is composed of a third index 316 indicating the logical address and a physical address 317 corresponding to the logical address. The physical address 317 indicated by the third table 304 indicates the physical address of the NAND flash memory 12 in which the 4-kilobyte data corresponding to the logical address is stored.

FIG. 2 illustrates that the first index 312 and the storage position 313 of the second table are arranged side by side as the first table 302. However, the arrangement of the table is not actually limited to that illustrated in FIG. 2. For example, the first index 312 may be set as a consecutive numerical value, wherein the first index 312 may be set as an index indicating an array, and the storage position 313 of the second table may be set as the content of the array, for example. The same applies to the second table and the third table. With this configuration, the memory area for physically storing the first index is unnecessary. The logical address in the logical address space 301 and the physical address in the physical address space 305 can be translated by using the first to third tables illustrated in FIG. 2.

FIG. 2 is only illustrative, and the total number of the logical addresses, the number of hierarchies, the number of the logical addresses bundled as one bundle for each hierarchy, and the method of applying the first index, the second index, and the third index are not limited to those illustrated in FIG. 2.

After determining the correspondence between the logical address and the physical address, the control unit 102 generates the first to third tables based upon this correspondence. Specifically, the control unit 102 firstly generates the third table, and decides the position (physical address) on the NAND flash memory 12 storing the third table. The control unit 102 then generates the second table based upon the storage position of the third table, and decides the position (physical address) on the NAND flash memory 12 storing the second table. Finally, the control unit 102 generates the first table based upon the storage position of the second table. The control unit 102 also instructs the NAND controller 111 to write the second table and the third table on the NAND flash memory 12 with the decided storage position being designated. The NAND controller 111 writes the second table and the third table on the NAND flash memory 12 based upon the instruction from the control unit 102. The first table may also be stored in the NAND controller 111.

Some of the first to third tables thus generated are stored in the address translation information storage unit 106 in the memory controller 11. The method of selecting which table is stored in the address translation information storage unit 106 is not limited. In general, the table that is supposed to be more frequently referred to is preferentially stored in the address translation information storage unit 106. For example, the first table is always stored in the address translation information storage unit 106. As for the second table and the third table, the one having the most recent date on which it is referred to is preferentially stored within the range permitted by the capacity of the address translation information storage unit 106. The address translation information storage unit 106 has an array structure of cache lines, each being indexed by a cache line number, as a matter of logic. Specifically, the address translation information storage unit 106 includes plural cache lines. In the present embodiment, one table is stored in one cache line.

When a table is stored in the address translation information storage unit 106, the memory controller 11 reads the table from the address translation information storage unit 106 in order to read each table as fast as possible. For this, the memory controller 11 has to search whether the table corresponding to the logical address to be translated is stored in the address translation information storage unit 106 or not. In the present embodiment, an address translation information cache line tag (hereinafter referred to as a cache line tag) is used for this search.

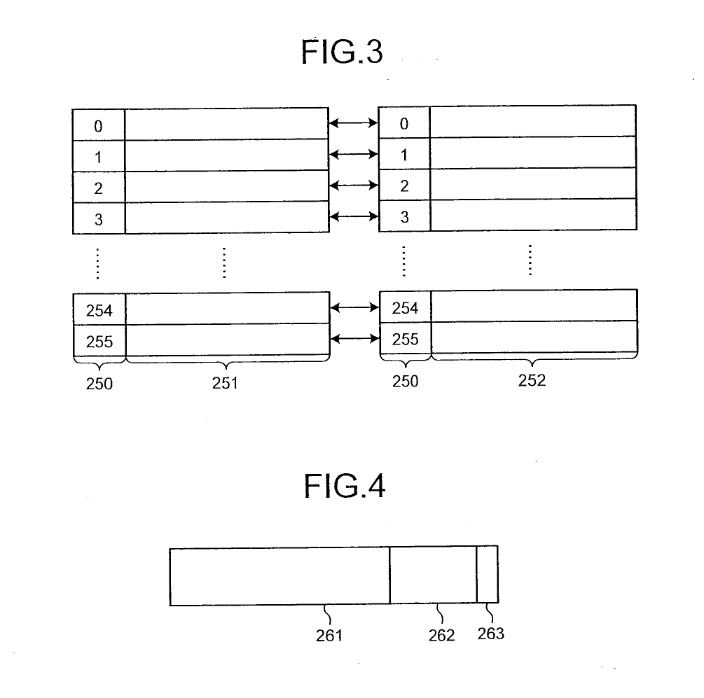

FIG. 3 is a view illustrating one example of a correspondence between the cache line and the cache line tag according to the present embodiment. The cache line and the cache line tag in the address translation information storage unit 106 have one-to-one correspondence. In other words, the table stored in the address translation information storage unit 106 and the cache line tag have one-to-one correspondence. As illustrated in FIG. 3, the cache line number 250 is an index for identifying the cache line 251, and is also an index for identifying the cache line tag 252.

The cache line tag is generated when the corresponding table is stored in the address translation information storage unit 106, and it is stored in a tag memory in the address translation information tag management unit 108. The tag memory has tag storage areas in the number equal to the number of the cache lines forming the address translation information storage unit 106. Each tag storage area is logically an array, for example. It is supposed that, in an initial state, the cache lines in the address translation information storage unit 106 and the tag storage area in the address translation information tag management unit 108 are both initialized (e.g., set to zero). When a table is stored in the cache line in the address translation information storage unit 106, the corresponding cache line tag in the address translation information tag management unit 108 is simultaneously updated. With this structure, a free cache line (a cache line having no table stored) can be searched by the search of the initialized cache line tag. It is supposed that the cache line in which a value indicating invalidity is stored in valid information of the cache line tag is defined as a free cache line.

FIG. 4 is a view illustrating an example of a configuration of the cache line tag. The cache line tag includes tag information 261, an information type 262, and valid information 263 for the cache line corresponding to the same cache line number. The tag information 261 is an index for identifying the table stored in the corresponding cache line. Specifically, the tag information 261 stores the first index, when the table stored in the cache line is the second table. The tag information 261 stores the second index, when the table stored in the cache line is the third table. The information type 262 is information indicating the type of the table (the second table or the third table) stored in the cache line. The valid information 263 is valid information indicating whether the table stored in the cache line is valid or not. When the table is updated since the physical address corresponding to the logical address is changed, and the table before the update is stored in the cache line, the valid information 263 corresponding to this cache line is changed to be invalid.

The information indicating the hierarchy of the table is contained in the cache line tag as the information type as illustrated in FIG. 4. Therefore, the hierarchy of the table stored in the address translation information storage unit 106 can be grasped by referring to the cache line tag. Accordingly, the search time for the table stored in the address translation information storage unit 106 can be shortened with the area storing the table of each hierarchy being not determined.

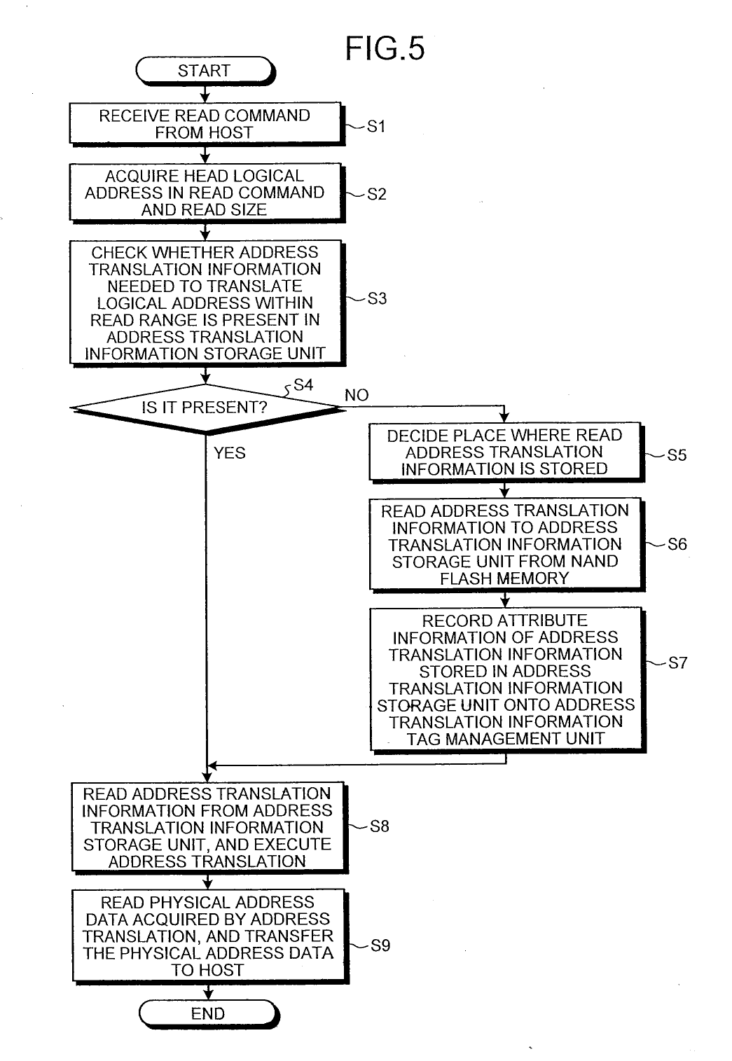

Subsequently, the operation upon the reception of the read command according to the present embodiment will be described. FIG. 5 is a flowchart illustrating one example of an operation procedure upon the reception of the read command. The memory controller 11 receives the read command from the host 2 (step S1). In the read command, the range (reading range) of the user data that is requested to be read is designated by the head logical address and the size (read size). The control unit 102 acquires the head logical address and the read size from the read command (step S2).

The control unit 102 checks whether the address translation information (table) needed to translate the logical address of the requested region into the physical address is present in the address translation information storage unit 106 or not (step S3). In this case, the control unit 102 does not directly search the content of the address translation information storage unit 106, but gives the information involved with the table to be searched to the address translation information tag management unit 108, and instructs the execution of the table search. The address translation information tag management unit 108 executes the table search based upon the instruction. The detail of the table search will be described later.

The control unit 102 determines whether the address translation information (table) needed for the reading process is stored in the address translation information storage unit 106 or not based upon the result of the table search by the address translation information tag management unit 108 (step S4). Specifically, when the tables of three hierarchies are used as illustrated in FIG. 2, for example, the control unit 102 determines in step S4 that the address translation information is stored in the address translation information storage unit 106, if all of the third tables corresponding to the logical address within the reading region are stored in the address translation information storage unit 106. On the other hand, when one or more of the third tables corresponding to the logical addresses of the requested region are not stored in the address translation information storage unit 106 as the address translation information, the control unit 102 determines that the address translation information is not stored in the address translation information storage unit 106.

When the address translation information is stored in the address translation information storage unit 106 (step S4, Yes), the control unit 102 reads the necessary address translation information from the address translation information storage unit 106 to execute the address translation (step S8). The control unit 102 instructs the NAND controller 111 to read the user data from the physical address acquired as a result of the address translation, controls to transfer the read user data to the host 2 (step S19), and then, ends the process.

When the address translation information is not present in the address translation information storage unit 106 (step S4, No), the control unit 102 decides on which position (cache line) in the address translation information storage unit 106 the address translation information (table) needed for the reading process is stored (step S5). Next, the control unit 102 controls to read the address translation information (table) needed for the reading process from the NAND flash memory 12 (step S6). Then, the control unit 102 stores the read address translation information (table) into the storage position in the address translation information storage unit 106 decided in step S5, records the cache line tag involved with the address translation information on the address translation information tag management unit 108 (step S7), and then, proceeds to step S8.

Like the user data, the error-correction coding process is executed to the address translation information (table) by the error correction unit 107, and the resultant is stored in the NAND flash memory 12. The parity corresponding to each table is also stored in the NAND flash memory 12. When each table is read from the NAND flash memory 12, the parity is read together. The error correction unit 107 executes the error correction process to the table by using the parity. The error correction process may be executed before or after the table is stored in the address translation information storage unit 106. The error correction is only executed before the control unit 102 refers to the table.

In step S9, the parity is read together with the user data read from the NAND flash memory 12, and the error correction process is carried out by using the parity and the user data. The user data after the error correction process is transferred to the host 2.

In the processes upon the reception of the read command described above, the processing time of the table search process (process of searching the address translation information) in step S3 becomes long when a lot of address translation information (table) is stored in the address translation information storage unit 106. It is desirable that the table search process is executed with high speed in order to quickly respond to the read command of the user data from the host 2.

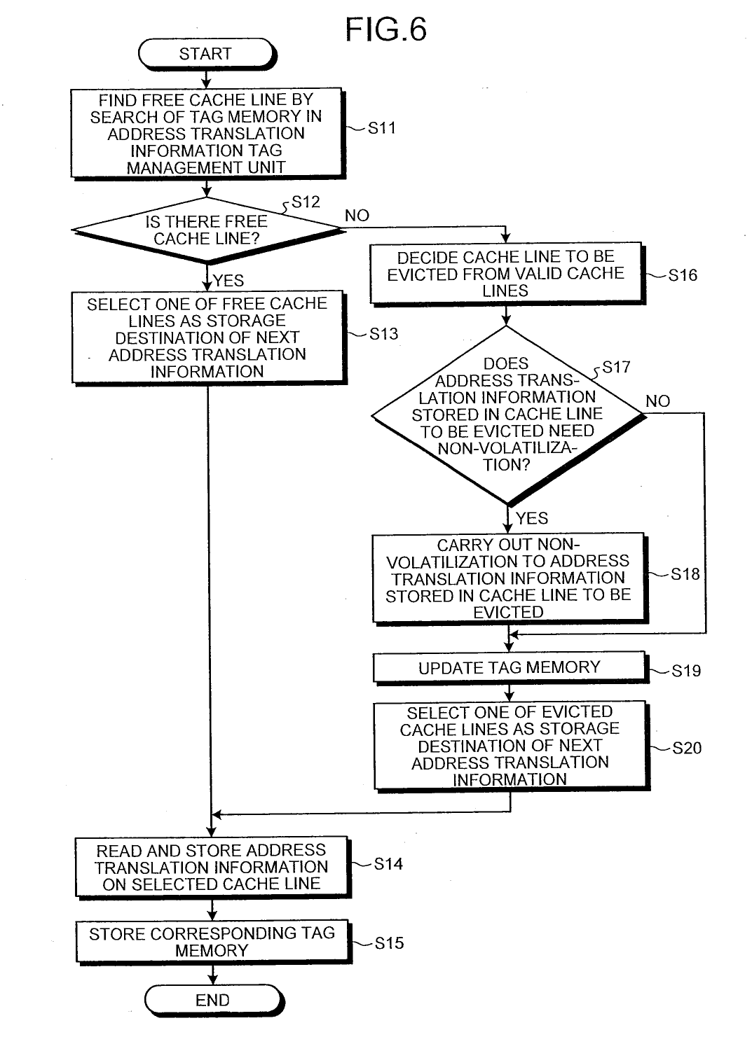

The process of reading the address translation information from the NAND flash memory 12 will be described next. FIG. 6 is a flowchart illustrating one example of a procedure of reading the address translation table from the NAND flash memory 12 according to the present embodiment. The process in FIG. 6 is executed when the control unit 102 determines that the address translation information used for the process by the control unit 102 is not stored in the address translation information storage unit 106 as a result of the table search process (step S4 in FIG. 5, No). In other words, the process in FIG. 6 is the detail of the processes in steps S6 and S7 in FIG. 5. The process in FIG. 6 may be executed when a fixed number of tables (the number of the cache lines forming the address translation information storage unit 106) are read from the state in which no table is read from the NAND flash memory 12 (the state in which all cache lines are initialized).

The control unit 102 searches a free cache line by searching the tag memory in the address translation information tag management unit 108 (step S11). The control unit 102 determines whether there are free cache lines or not (step S12). When there are free cache lines (step S12, Yes), the control unit 102 selects one of the free cache lines as the storage destination of the next address translation information (address translation table) (step S13). The control unit 102 reads the address translation table (one or more of the second table and the third table) from the NAND flash memory 12, and stores the read table into the selected cache line (step S14). The control unit 102 also stores the cache line tag, which is generated based upon the information of the read table, into the tag storage area in the tag memory in the address translation information tag management unit 108 corresponding to the selected cache line (step S15). In this case, the valid information of the cache line tag is set to a value indicating validity.

When there is no free cache line (step S12, No), the control unit 102 grasps the valid cache line by referring to the tag memory in the address translation information tag management unit 108, and decides the cache line that is to be evicted out of the valid cache lines (step S16). Specifically, the control unit 102 acquires the information of the cache line tag having the valid information indicating validity by referring to the cache line tag in the address translation information tag management unit 108. The control unit 102 then decides the cache line that is to be evicted based upon the acquired information. For example, the control unit 102 can manage the update time of the cache line or the cache line tag, and sequentially evicts the cache line having the older update time.

Next, the control unit 102 determines whether the table stored in the cache line that is to be evicted needs non-volatilization (needs to be stored in the NAND flash memory 12) or not (step S17). When the non-volatilization is needed (step S17, Yes), the control unit 102 executes non-volatilization of the table stored in the cache line that is to be evicted (step S18). The case where the non-volatilization of the table stored in the cache line which is to be evicted is needed means that the same information as the table is not stored in the NAND flash memory 12.

Next, the control unit 102 updates the cache line tag in the address translation information tag management unit 108 (step S19). Specifically, the control unit 102 changes the value of the valid information in the cache line tag corresponding to the cache line to be evicted to a value indicating the information is invalid. Thus, the cache line that is to be evicted becomes reusable, and is evicted from the address translation information storage unit 106. The control unit 102 selects one of the evicted cache lines as the storage destination of the next table (step S20), and then, proceeds to step S14. When the non-volatilization is not needed in step S17 (step S17, No), the control unit 102 proceeds to step S19.

According to the process described above, the table is stored in the cache line, and the cache line tag corresponding to the table is stored in the address translation information tag management unit 108, when the table is referred to.

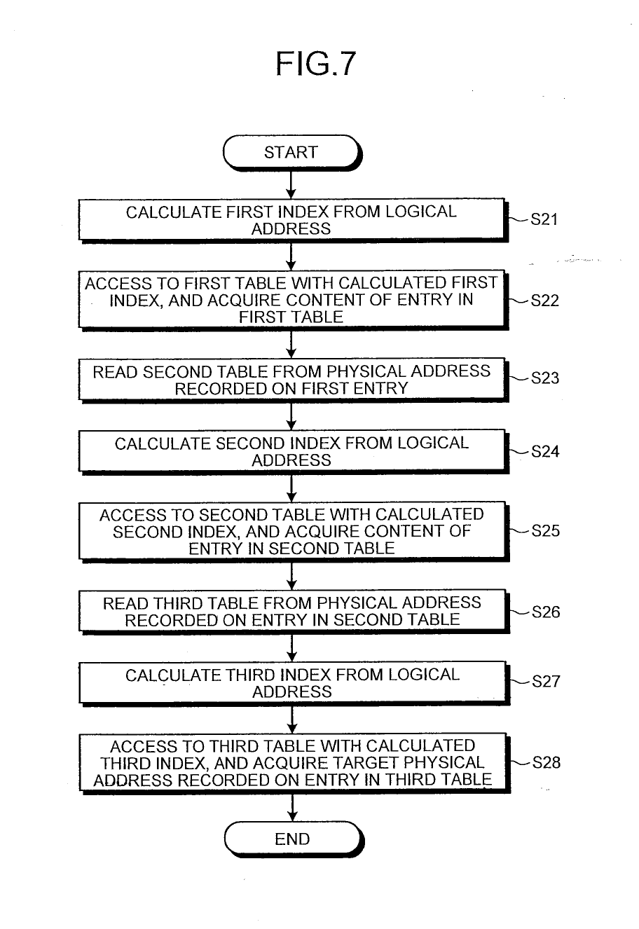

FIG. 7 is a view illustrating one example of the address translation process. FIG. 7 illustrates the procedure of the address translation process when the first table is stored in the address translation information storage unit 106 and the second table and the third table are not stored in the address translation information storage unit 106. The process in FIG. 7 is the detail of the processes in steps S6, S7, and S8 in FIG. 5 for each hierarchy.

Firstly, the control unit 102 calculates the first index from the logical address (step S21). The control unit 102 accesses to the first table by using the calculated first index, and acquires a first table entry (step S22). Specifically, the control unit 102 acquires the storage position (physical address) of the second table that is the information of the entry, corresponding to the calculated first index, in the first table.

The control unit 102 instructs the NAND controller 111 to read the second table from the acquired storage position (physical address) of the second table. The NAND controller 111 reads the second table, and stores the read second table into the address translation information storage unit 106 based upon the instruction (step S23).

The control unit 102 calculates the second index from the logical address (step S24). The control unit 102 accesses to the second table by using the calculated second index, and acquires a second table entry (step S25). Specifically, the control unit 102 acquires the storage position (physical address) of the third table that is the information of the entry, corresponding to the calculated second index, in the second table.

The control unit 102 instructs the NAND controller 111 to read the third table from the acquired storage position (physical address) of the third table. The NAND controller 111 reads the third table, and stores the read third table into the address translation information storage unit 106 based upon the instruction (step S26).

The control unit 102 calculates the third index from the logical address (step S27). The control unit 102 accesses to the third table by using the calculated third index, and acquires a third table entry (step S28). Specifically, the control unit 102 acquires the storage position (physical address) of the physical address that is the information of the entry, corresponding to the calculated third index, in the third table. According to the process described above, the physical address corresponding to the logical address can be acquired.

An example of the address translation will be described by using the first to third tables illustrated in FIG. 2. For example, an example of obtaining the physical address corresponding to the logical address of 0x8001 by the memory controller 11 will be described. Here, the first table is held in the memory controller 11, and the second and third tables are stored in the NAND flash memory 12. The first table in FIG. 2 bundles 16384 logical addresses. The first index corresponding to the hatched logical address 0x8001 in the left end in FIG. 2 is 2, which is the quotient of 0x8001 divided by 16384. Therefore, the memory controller 11 refers to the entry (the hatched entry) in which the first index of the first table 302 is 2 in FIG. 2 so as to obtain the storage position of the second table 303. Then, the memory controller 11 reads the second table 303 from the obtained storage position.

The remainder of dividing 0x8001 by 16384 is 1, and the quotient of dividing 1 by 128 is 0. Therefore, the second index corresponding to the logical address 0x8001 is 0. Therefore, the memory controller 11 refers to the entry (the hatched entry) in which the second index of the read second table 303 is 0 so as to obtain the storage position of the third table 304. Then, the memory controller 11 reads the third table 304 from the obtained storage position. The remainder of dividing 0x8001 by 16384 is 1, and the remainder of dividing 1 by 128 is 1. Therefore, the third index corresponding to the logical address 0x8001 is 1. Therefore, the memory controller 11 refers to the entry (the hatched entry) in which the third index of the read third table 304 is 1 so as to obtain the physical address 0x8000. In this way, the physical address 0x8000 corresponding to the logical address 0x8001 can be obtained.

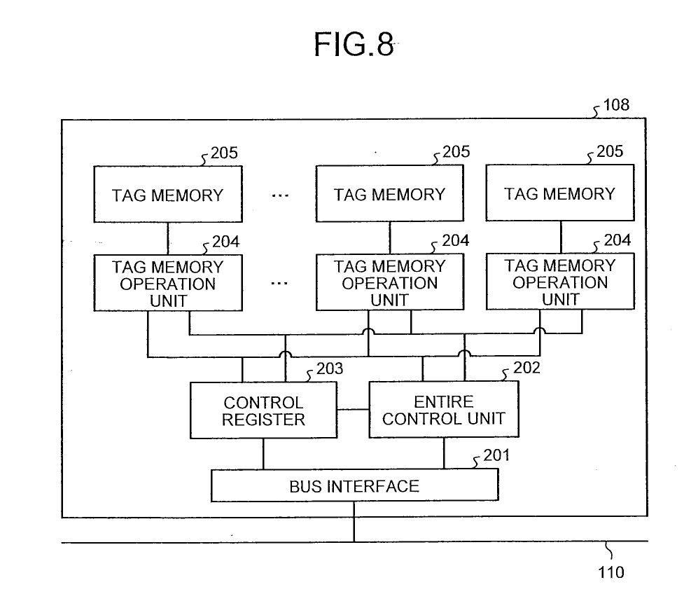

Subsequently, the table search process will be described. In the present embodiment, the address translation information tag management unit 108 executes the table search process by using the above-mentioned cache line tag. FIG. 8 is a view illustrating an example of a configuration of the address translation information tag management unit 108. As illustrated in FIG. 8, the address translation information tag management unit 108 includes plural tag memories 205, plural tag memory operation units 204 connected to the corresponding tag memories in one-to-one manner, a control register 203, an entire control unit 202, and a bus interface 201. In the configuration illustrated in FIG. 8, plural tag memories 205 and plural tag memory operation units 204 are provided to enable the parallel table search in order to speed up the table search process. However, the address translation information tag management unit 108 may include only one tag memory 205 and only one tag memory operation unit 204.

The address translation information tag management unit 108 is connected to the control bus 110 via the bus interface 201. The bus interface 201 is connected to the control register 203 and the entire control unit 202. The control register 203 and the entire control unit 202 are connected to one or more sets of the tag memory 205 and the tag memory operation unit 204. The entire control unit 202 sets information for carrying out the search based upon the instruction from the control unit 102 to the control register 203. For example, the entire control unit 202 sets the information to be searched out of the tag information, the type information, and the valid information to the control register 203. The tag memory operation unit 204 searches the cache line tag, which has the information agreeing with the information set to the control register 203, in the tag memory 205.

The number of the tag memories 205 and the number of the tag memory operation units 204 can be decided according to the size of the address translation information storage unit 106 and the permitted table search time. In general, when the size of the address translation information storage unit 106 increases, the number of the tag memories 205 and the number of the tag memory operation unit 204 are desirably increased. When the permitted table search time is shortened, the number of the tag memories 205 and the number of the tag memory operation unit 204 are desirably increased.

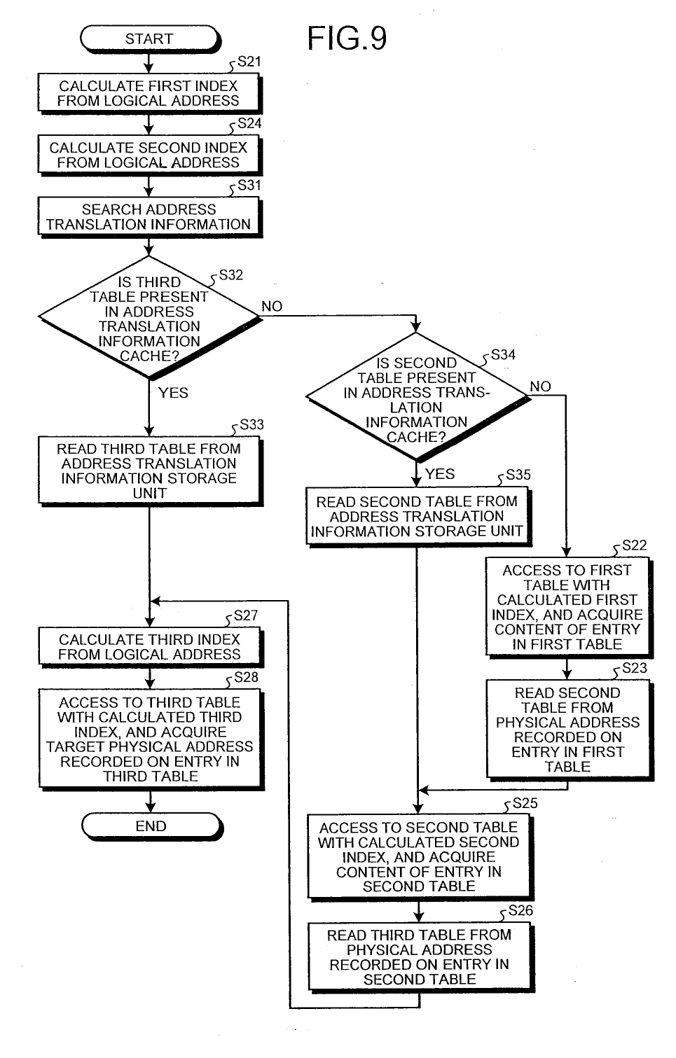

FIG. 5 illustrates the case in which the address translation process is executed after the execution of the table search process. However, it is actually effective if the address translation process is executed simultaneous with the table search of the second table and the third table. For example, the processes corresponding to the processes in steps S3 to S8 in FIG. 5 can be carried out in the procedure illustrated in FIG. 9. FIG. 9 is a view illustrating one example of the procedure of the table search and the address translation process. The step of the process same as the process in FIG. 7 is identified by the same step number as in FIG. 7.

As in step S21 in FIG. 7, the first index is calculated (step S21), and as in step S24 in FIG. 7, the second index is calculated (step S24). Then, the address translation information tag management unit 108 searches whether the second table corresponding to the calculated first index or the third table corresponding to the calculated second index is stored in the address translation information storage unit 106 or not (step S31). Specifically, the tag memory operation unit 204 searches whether the cache line tag having the tag information agreeing with the calculated first index, having the type information indicating the second table, and having the valid information indicating validity is stored in the tag memory 205 or not. Simultaneously, the tag memory operation unit 204 searches whether the cache line tag having the tag information agreeing with the calculated second index, having the type information indicating the third table, and having the valid information with the value indicating validity is stored in the tag memory 205 or not.

The control unit 102 determines whether the third table is stored in the address translation information storage unit 106 (the address translation information cache) (step S32). When the third table is stored (step S32, Yes), the control unit 102 reads the third table from the address translation information storage unit 106 (step S33). Then, the control unit 102 executes the processes in steps S27 and S28, which are the same as those in FIG. 7, and then, ends the process.

When the third table is not stored in the address translation information storage unit 106 (step S32, No), the control unit 102 determines whether the second table is stored in the address translation information storage unit 106 (step S34). When the second table is stored (step S34, Yes), the control unit 102 reads the second table from the address translation information storage unit 106 (step S35). Then, the control unit 102 executes the processes in steps S25 and S26, which are the same as those in FIG. 7, and then, proceeds to step S27.

When the second table is not stored in the address translation information storage unit 106 (step S34, No), the control unit 102 executes the processes in steps S22 and S23, which are the same as those in FIG. 7, and proceeds to step S25.

As described above, the cache line tag can logically be configured as an array. Therefore, when there are two or more tag memories 205, plural cache line tags are divided into the number of the tag memories, and stores each of the divided cache lines into each of the tag memories 205. For example, when the total number of the cache line tags is 256, and eight tag memories 205 are provided, each tag memory 205 stores 32 cache line tags.

If all of eight tag memories 205 are simultaneously searched during the search in step S32 in FIG. 9 in this configuration, the search is ended in the time ⅛ the time taken for searching 256 cache line tags one by one.

The tag memory operation unit 204 searches the cache line tag, which has the information agreeing with various information set to the control register 203. In this case, when there is a cache line having the tag information agreeing with the tag information set to the control register 203, having the type information agreeing with the type information set to the control register 203, and having the valid information with the value indicating validity, this cache line is determined to satisfy the search condition. Even when either one of the tag information and the type information does not agree, or when the valid information indicates invalidity, this cache line is determined not to satisfy the search condition. In this way, the address translation information tag management unit 108 can identify whether the corresponding table is stored in the address translation information storage unit 106 or not by using the cache line.

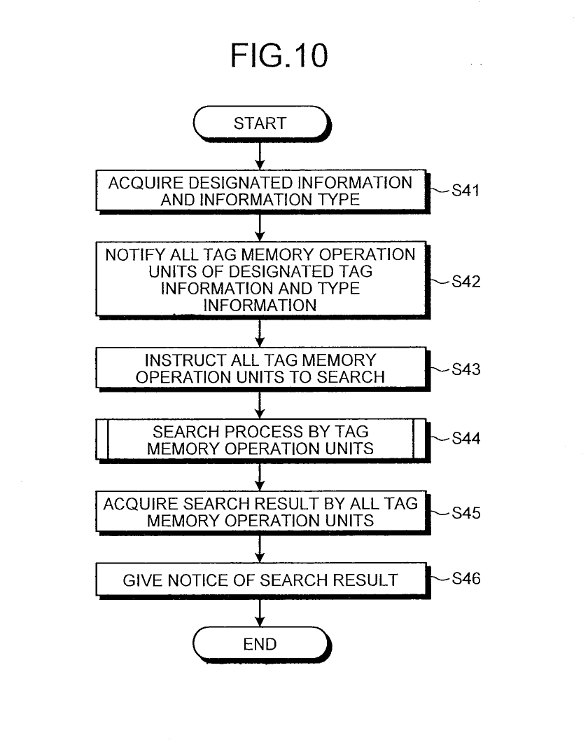

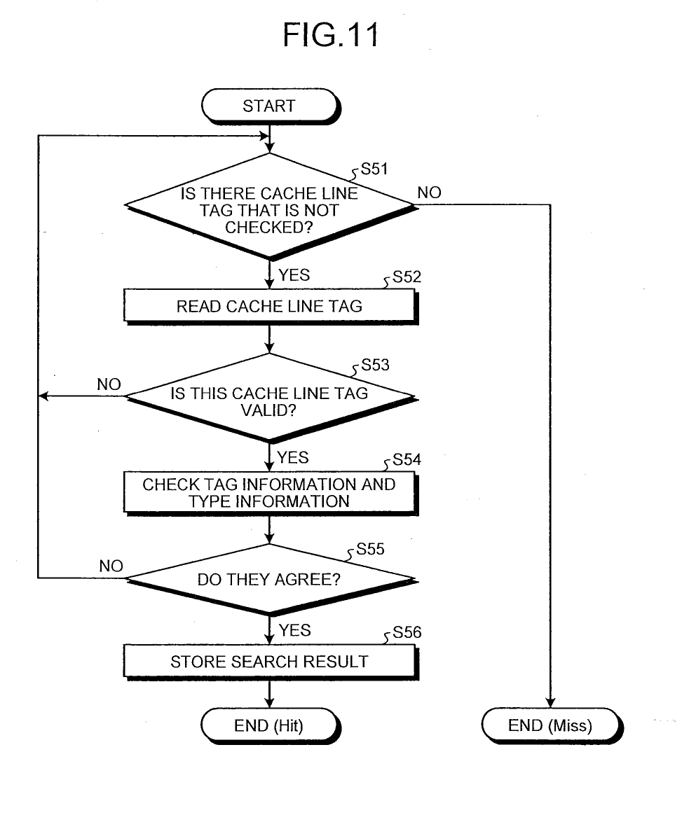

Specifically, the address translation information tag management unit 108 executes a process according to flowcharts in FIGS. 10 and FIG. 11, for example. FIG. 10 is a flowchart illustrating one example of an overall process of the search in the address translation information tag management unit 108. FIG. 11 is a flowchart illustrating one example of a process executed by the tag memory operation unit 204.

As illustrated in FIG. 10, the entire control unit 202 acquires the tag information and the type information of the target to be searched, when receiving the request of the search process from the control unit 102 via the control bus 110 and the bus interface 201 (step S41). The control unit 102 gives notice of the tag information and the type information of the target to be searched upon the request of the search process to the address translation information tag management unit 108.

The entire control unit 202 sets the tag information and the type information of the target to be searched to the control register 203, thereby notifying all tag memory operation units 204 of the designated tag information and the type information (step S42). Next, the entire control unit 202 instructs all tag memory operation units 204 to execute the search process (step S43). The tag memory operation unit 204 performs the search process based upon the designated tag information and the type information (step S44). After the entire control unit 202 acquires the search result of the tag memory operation units 204 (step S45) and the search process of the tag memory operation units 204 is ended, the entire control unit 202 notifies the control unit 102 of the search result (step S46), and then, ends the search process.

In this embodiment, the entire control unit 202 sets the tag information and the type information of the target to be searched to the control register 203, thereby notifying all tag memory operation units 204 of the designated tag information and the type information. However, the method of the notification of the tag information and the type information is not limited thereto. The notification of the request of the search process from the control unit 102 may be made by writing to the control register 203 from the control unit 102. The instruction of the search condition may directly be written onto the control register 203 from the control unit 102. The control unit 102 may be notified of the search result by the writing onto the control register 203. Any method, such as an interruption, can be employed for notifying the control unit 102 of the search result and the completion of the search from the entire control unit 202.

As illustrated in FIG. 11, when receiving the instruction of the execution of the search process from the entire control unit 202, the tag memory operation unit 204 determines whether a cache line tag that is not checked is present in the tag memory 205 or not (step S51). When there is a cache line tag that is not checked (step S51, Yes), the tag memory operation unit 204 reads the cache line tag that is not checked from the tag memory 205 (step S52).

The tag memory operation unit 204 determines whether the valid information of the read cache line tag has the value indicating validity or not (step S53). When the value of the valid information of the cache line tag indicates validity (step S53, Yes), the tag memory operation unit 204 checks whether or not the tag information and the type information of the read cache line tag agree with the designated information (step S54). The tag memory operation unit 204 determines whether or not both the tag information and the type information agree with the designated information (step S55), and when they agree with each other (step S55, Yes), it stores this cache line as the search result (step S56), and ends the process.

When it is determined that there is no cache line tag that is not checked in the tag memory 205 in step S51 (step S51, No), the process is ended. When the value of the valid information in the read cache line tag indicates invalidity in step S53 (step S53, No), the process returns to step S51. When at least either one of the tag information and the type information does not agree with the designated one in step S55 (step S55, No), the process returns to step S51.

In the above description, it is supposed that the address translation information tag management unit 108 specifies all cache line tags as the targets to be searched in the search process. However, it is not limited thereto. The address translation information tag management unit 108 may specify only the cache line tags within a predetermined range designated by the control unit 102 as the targets to be searched. For example, the control unit 102 designates the range of the cache line number as the search range, and the address translation information tag management unit 108 executes only the search in the tag memory 205 that stores the cache line tags within the designated range of the cache line number. The control unit 102 can instruct the search range by setting the search range to the control register 203, for example.

As described above, the present embodiment manages the user data in the memory system 1 by using the address translation information (table) of plural hierarchies. The memory area in the address translation information storage unit 106 for holding the address translation information in the memory controller 11 is not divided for each hierarchy, but the cache line tag having one-to-one correspondence to the table stored in the address translation information storage unit 106 is held. The information indicating the hierarchy is applied to the cache line tag, and whether the table is stored in the address translation information storage unit 106 or not is searched by using the cache line tag. Accordingly, the memory area in the address translation information storage unit 106 can effectively be utilized, and the search time can be shortened. Consequently, a quick response to the user data read/write command from the host 2 becomes possible. When the search process is executed in parallel, the search time can further be shortened.

### Second Embodiment

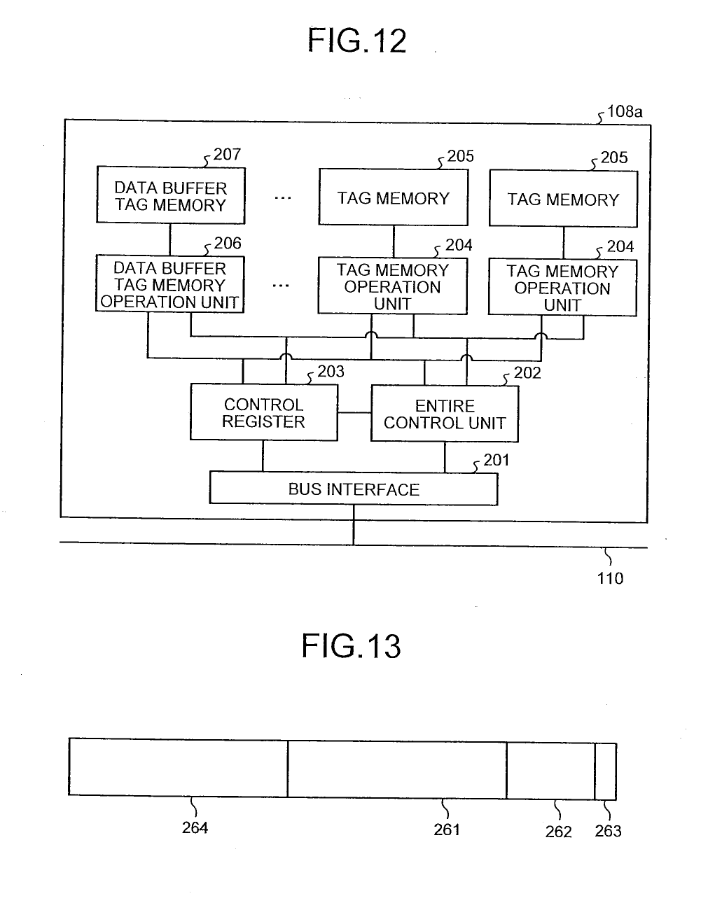

FIG. 12 is a view illustrating an example of a configuration of an address translation information tag management unit 108a according to a second embodiment. A memory system 1 according to the present embodiment is the same as that in the first embodiment except that the address translation information tag management unit 108 in the first embodiment is replaced by an address translation information tag management unit 108a. The address translation process and the table search process in the present embodiment are the same as those in the first embodiment. In the present embodiment, when user data is stored in a data buffer 104, this information is recorded in the address translation information tag management unit 108a.

The address translation information tag management unit 108a is the same as the address translation information tag management unit 108 in the first embodiment except that a data buffer tag memory 207 (data tag memory) and a data buffer tag memory operation unit 206 (data tag operation unit) are added to the address translation information tag management unit 108 in the first embodiment. The components having functions same as those in the first embodiment are identified by the same numerals, and the redundant description will not be repeated.

When storing the user data into the data buffer 104, a control unit 102 stores a data tag in the data buffer tag memory 207. The case where the user data is stored in the data buffer 104 is the case where the user data is received upon the reception of the write command from a host 2, and this user data is stored in the data buffer 104, and the case where the user data is read from NAND flash memory 12 upon the reception of the read command from the host 2, and this user data is stored in the data buffer 104.

The data tag includes a logical address range of the user data to be stored, and valid information indicating validity or invalidity. Any unit may be employed as the unit of the user data generating the data tag. The logical address range can be designated by a head logical address and a data size, for example. The control unit 102 stores a value indicating validity as the valid information when storing the user data in the data buffer 104. The control unit 102 changes the value of the valid information of the corresponding data tag to a value indicating invalidity, when the user data is erased from the data buffer 104 (the user data is overwritten by other data).

When receiving the read command, for example, the control unit 102 designates the logical address to the address translation information tag management unit 108a, and instructs to search the corresponding data tag. The data buffer tag memory operation unit 206 searches the data tag, corresponding to the designated logical address, in the data buffer tag memory 207, and when the corresponding data tag is present, it notifies the control unit 102 of this data tag as the search result. When there is no corresponding data tag, the data buffer tag memory operation unit 206 informs the control unit 102 of this situation. When there is the corresponding data tag as a result of the search, the control unit 102 reads the user data from the data buffer 104. When there is no corresponding data tag, the control unit 102 executes a process of reading the user data from the NAND flash memory 12.

FIG. 12 illustrates that only one set of the data buffer tag memory 207 and the data buffer tag memory operation unit 206 is provided. However, the address translation information tag management unit 108a may include plural sets of the data buffer tag memory 207 and the data buffer tag memory operation unit 206. This configuration enables parallel processing, whereby the search process can be performed with higher speed.

It may be configured such that the table search process of the address translation information described in the first embodiment and the search process as to whether the user data stored in the data buffer 104 is stored or not can be executed in parallel.

As described above, in the present embodiment, the data tag corresponding to the user data stored in the data buffer 104 is stored in the address translation information tag management unit 108a, and it can be determined whether the user data is stored in the data buffer 104 or not by using the data tag. Therefore, the memory controller 11 can determine with high speed whether not only the address translation information but also the user data are held in the memory controller 11 or not.

### Third Embodiment

FIG. 13 is a view illustrating an example of a configuration of a cache line tag according to the present embodiment. The cache line tag according to the present embodiment is formed by adding last reference time information 264 to the cache line tag in the first embodiment. The configuration of the memory system according to the present embodiment is the same as that of the memory system 1 according to the first embodiment.

In the present embodiment, a control unit 102 stores the last reference time of the table corresponding to the cache line tag. In steps S11 and S12 in FIG. 6, the control unit 102 searches a free cache line, and determines whether there is a free cache line or not. In the present embodiment, the last reference time information is referred to, when there is no initialized cache line tag, and there is no cache line tag having the valid information with the value indicating invalidity is stored, in the process described above.

Specifically, the control unit 102 instructs an address translation information tag management unit 108 to execute the process of searching a free cache line. A tag memory operation unit 204 searches a tag memory 205 according to the instruction from the control unit 102. When there is a cache line tag that is initialized or a cache line tag storing a value indicating invalidity, a tag memory operation unit 204 notifies an entire control unit 202 of this cache line tag as the search result. When the search result is not obtained from the tag memory operation unit 204, the entire control unit 202 instructs the tag memory operation unit 204 to search the cache line tag having the oldest last reference time. The tag memory operation unit 204 notifies the entire control unit 202 of the information of the cache line tag having the last reference time information indicating the oldest time. The entire control unit 202 selects the cache line tag having the last reference time information indicating the oldest time out of the cache line tags, which are notified from each of the tag memory operation units 204 and have the last reference time information indicating the oldest time, and notifies the control unit 102 of the selected cache line tag as the free cache line.

As described above, in the present embodiment, the information indicating the last reference time of the table corresponding to the cache line tag is added, and the cache line storing the table having the last reference time information indicating the oldest time is selected as the free cache line. Therefore, when there is no free cache line, the table can be removed from the cache line in the order of the table having the oldest reference time, whereby the cache line can effectively be utilized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that controls non-volatile memory, the memory controller comprising:
an address translation information storage unit configured to store some of plural translation information formed by classifying a correspondence between the logical address and a physical address, which is an address in the non-volatile memory, into two or more hierarchies;
a tag management unit configured to store a cache line tag which is generated when the translation information is stored in the address translation information storage unit, the cache line tag performing one-to-one correspondence to the translation information and including information indicating the hierarchy of the corresponding translation information; and
a control unit configured to identify ,using the cache line tag, whether the translation information used for translating the logical address into the physical address is stored in the address translation information storage unit or not.

2. The memory controller according to claim 1, wherein the control unit identifies whether the translation information is stored in the address translation information storage unit or not in order from the lowermost hierarchy to the uppermost hierarchy.

3. The memory controller according to claim 2, wherein
at least one of the translation information among the plural translation information is stored in the non-volatile memory,
the control unit translates the logical address into the physical address based upon the translation information of the lowermost hierarchy when the translation information of lowermost hierarchy is stored in the address translation information storage unit,
when the translation information of the lowermost hierarchy is not stored in the address translation information storage unit and the translation information of a next hierarchy is stored in the address translation information storage, the control unit controls to read out the translation information of the lowermost hierarchy from the non-volatile memory based upon the translation information of the next hierarchy, and translates the logical address into the physical address based upon the translation information of the lowermost hierarchy.

4. The memory controller according to claim 1, further comprising:
a first interface configured to receive write data and a logical address corresponding to the write data from a host; and
a second interface configured to write the translation information onto the non-volatile memory, and to write the write data onto the physical address in the non-volatile memory, wherein,
the control unit translates the logical address into the physical address based upon the translation information which is stored in the address translation information storage unit when the translation information is stored in the address translation information storage unit,
the control unit translates the logical address into the physical address based upon the translation information which is stored in the non-volatile memory when the translation information is not stored in the address translation information storage unit.

5. The memory controller according to claim 1, wherein the translation information of the lowermost hierarchy includes an index calculated based upon the logical address and the physical address, the translation information of the hierarchies other than the lowermost hierarchy including an index calculated based upon the logical address and a physical address indicating a storage position of the translation information of the next hierarchy on the non-volatile memory.

6. The memory controller according to claim 1, wherein
the tag management unit includes:
a tag memory configured to hold the cache line tag; and
a tag memory operation unit configured to search the cache line tag held in the tag memory based upon a search condition instructed from the control unit, wherein
the control unit instructs to the tag management unit the search condition for searching the translation information used for translating the logical address into the physical address, and when the tag memory operation unit acquires a cache line tag, which agrees with the search condition, as a search result, the control unit identifies that the translation information is stored in the address translation information storage unit.

7. The memory controller according to claim 2, wherein
the tag management unit includes the plural tag memories and the plural tag memory operation units, wherein
cache line tags are distributed and stored in the plural tag memories, and
each of the tag memory operation units has one-to-one correspondence with each of the tag memories, and searches the cache line tag in the corresponding tag memory.

8. The memory controller according to claim 6, wherein a part of the tag memory is excluded from the target to be searched.

9. The memory controller according to claim 1, further comprising:
a data buffer configured to temporarily store user data, wherein
the tag management unit holds a data tag that has one-to-one correspondence to the user data stored in the data buffer, and that is generated when the user data is stored in the data buffer, and
the control unit identifies whether the user data is stored in the data buffer or not by using the data tag.

10. The memory controller according to claim 1, wherein
the tag management unit includes:
a tag memory configured to hold the cache line tag;
the data tag memory configured to hold the data tag;
a tag memory operation unit configured to search the cache line tag held in the tag memory based upon a search condition instructed by the control unit; and
a data tag memory operation unit configured to search the data tag held in the data tag memory based upon a data search condition instructed by the control unit, wherein
the control unit instructs to the tag management unit the search condition for searching the translation information used for translating the logical address into the physical address, and when the tag memory operation unit acquires the cache line tag agreeing with the search condition as a search result, the control unit identifies that the translation information is stored in the address translation information storage unit, while the control unit instructs to the tag management unit the data search condition for searching the write data, and when the data tag memory operation unit acquires the data tag agreeing with the search condition as the search result, the control unit identifies that the write data is stored in the data buffer.

11. The memory controller according to claim 10, wherein at least either one of a part of the tag memory and a part of the data tag memory is excluded from the target to be searched.

12. The memory controller according to claim 1, wherein
the cache line tag further includes information indicating that the corresponding translation information is valid or not, and a last reference time of the translation information, and
the control unit instructs the tag management unit to search a free area upon searching a free area in the address translation information storage unit for storing new translation information, and
when there is the cache line in which the translation information is invalid, the tag management unit receiving the instruction of searching the free area notifies the control unit of a storage are, in which the translation information corresponding to the cache line tag is stored, in the address translation information storage unit as a free area, and when there is no cache line in which the translation information is invalid, the tag management unit notifies the control unit of a storage area, in which the translation information corresponding to a cache line tag with the oldest last reference time is stored, in the address translation information storage unit as a free area.

13. A semiconductor memory system comprising:
non-volatile memory;
an address translation information storage unit configured to hold some of plural translation information formed by classifying a correspondence between the logical address and a physical address, which is an address in the non-volatile memory, into two or more hierarchies;
a tag management unit configured to store a cache line tag which is generated when the translation information is stored in the address translation information storage unit, the cache line tag performing one-to-one correspondence to the translation information and including information indicating the hierarchy of the corresponding translation information; and
a control unit configured to identify ,using the cache line tag, whether the translation information used for translating the logical address into the physical address is stored in the address translation information storage unit or not.

14. A memory control method in a memory controller controlling non-volatile memory, the method comprising:
storing some of plural translation information , in an address translation information storage, formed by classifying a correspondence between the logical address and a physical address, which is an address in the non-volatile memory, into two or more hierarchies;
storing a cache line tag which is generated when the translation information is stored in the address translation information storage unit, the cache line tag performing one-to-one correspondence to the translation information and including information indicating the hierarchy of the corresponding translation information; and
identifying whether the translation information used for translating the logical address into the physical address is stored in the address translation information storage unit or not by using the cache line tag.
